(19) United States
(12) Patent Application Publication
(10) Pub. No.: US 2012/0230147 A1
(43) Pub. Date: Sep. 13, 2012

(54) PORTABLE CEMENT MIXING APPARATUS

(76) Inventors: Stephen J. Heller, Shakopee, MN (US); Joseph Kreuser, Shakoppe, MN (US); James Bauer, Shakopee, MN (US)

(21) Appl. No.: 13/427,595

(22) Filed: Mar. 22, 2012

Related U.S. Application Data
(63) Continuation-in-part of application No. 12/276,044, filed on Nov. 21, 2008, now abandoned.
(60) Provisional application No. 60/991,116, filed on Nov. 29, 2007.

(51) Int. Cl. B01F 15/04

(52) U.S. Cl. 366/141

(57) ABSTRACT

A system for forming a cementitous slurry comprising at least water or other liquid and at least one flowable particulate mass such as sand or cement has computerized control of loading the ingredients into a mixing chamber. The mixing chamber has a scale that provides a signal indicating the current weight of the mixing chamber. The computer monitors the weight of the mixing chamber as these ingredients are individually loaded into the mixing chamber. When the desired weight of a particular ingredient has been loaded, the computer halts the delivery of that ingredient. Ingredients are loaded first at a relatively high rate, and then as the desired weight of material in the mixing chamber approaches, the rate slows.

### CROSS-REFERENCE TO RELATED APPLICATIONS

This is a continuation-in-part application filed under 37 CFR §53(b) claiming priority under 35 U.S.C. §120 of co-pending U.S. patent application Ser. No. 12/276,044 filed on Nov. 21, 2008, which is a regular application filed under 35 U.S.C. §111(a) claiming priority, under 35 U.S.C. §119(e)(1), of provisional application Ser. No. 60/991,116, previously filed Nov. 29, 2007 under 35 U.S.C. §111(b).

### BACKGROUND OF THE INVENTION

The present invention is directed to transportable mixing apparatus for cement operated at the construction site.

### BRIEF DISCUSSION OF THE RELATED ART

Gypsum is a frequently-employed material for constituting building floor underlayments and other non-structural purposes. Gypsum is to be distinguished from concrete in that it has a different chemical formulation and different characteristics after mixing and before hardening. One important difference is its high fire resistance compared to concrete's low resistance.

Gypsum is formed by mixing water, gypsum powder, and sand in the correct proportions, and allowing the slurry so formed, to harden. Once mixing is complete, the gypsum slurry's useful life is very short (typically, less than 45 min.) as opposed to at least 90 min. for concrete. Therefore, gypsum must usually be mixed at the actual job site, whereas concrete can be mixed at a central plant and delivered to the job site.

The mixed slurry is then poured into the desired area and quickly leveled. The slurry soon hardens into an underlayment forming the desired floor, or possibly other surface.

Hardened gypsum material (hereafter “final product”) is a composite made up of a filler (i.e., sand), the gypsum powder binder, and a small amount of residual water. The binder glues the filler together to form a stable, fire-resistant material.

To form the final product, water and gypsum powder are first mixed. Adding the filler, usually fine or coarse aggregates of sand, to the water and gypsum mixture, and then stifling the material for a suitable period completes the mixing process and produces a pourable slurry. Typically, 60-80% by weight of the final product is aggregate.

Water is a key ingredient when producing the gypsum slurry. When water is mixed with gypsum a chemical process called hydration causes the slurry to harden to a solid final product with the gypsum binding the aggregates together. The water to gypsum ratio is a critical factor in determining the quality of the ultimately produced final product. Too much water reduces final product strength, while too little water will make the slurry difficult to work and shape into a desired configuration. Accordingly, it is important that the appropriate water to gypsum ratio be achieved when mixing the precursor slurry.

Different applications require different hardness of the final product. The hardness is typically varied by adjusting the concentrations of sand and water relative to the concentration of gypsum in the slurry mixture. Typically, a greater relative concentration of gypsum results in greater underlayment hardness. Underlayment hardness is typically varied between 1,000 psi to 7000 psi, with more demanding applications (e.g., areas that will experience relatively high foot traffic) requiring a harder underlayment.

It is often desirable to select the hardness for a particular installation since installations often require a specific hardness. For example, a floor intended to be covered by vinyl typically requires a hardness of 2,500 psi. Where a construction project requires a specific hardness of the underlayment, the contractor will usually prefer to provide underlayment with no more hardness than required so as to contain costs. However, accurately controlling the ingredient proportions for the underlayment has been difficult because measuring the amount of each of the ingredients being added is difficult to accurately control. Because of this inexact processes employed for creating and mixing gypsum underlayment, it is often highly difficult to produce a desired psi hardness with any degree of precision or accuracy, especially when attempted in the field.

### SUMMARY OF THE INVENTION

A system for forming a cementitous slurry comprising at least water or other liquid and at least one flowable particulate mass such as sand or cement uses a computer to control loading of the ingredients into a mixing chamber. The mixing chamber has a scale that provides a signal indicating the current weight of the mixing chamber. The computer monitors the weight of the mixing chamber as these ingredients are individually loaded into the mixing chamber. When the desired weight of a particular ingredient has been loaded, the computer halts the delivery of that ingredient.

Such system delivers preselected weights of a liquid and at least a first particulate mass material to the mixing chamber. The system comprises at least sources for the liquid and the particulate mass and a mixing chamber.

First and second delivery devices sequentially and separately transport the liquid and the at least one particulate mass material to the mixing chamber responsive to first and second delivery control signals. Each delivery control signal has a second value causing the associated delivery device to transport the associated material to the mixing chamber, and a first value stopping the associated delivery device from transporting the associated material to the mixing chamber.

A scale supports at least a portion of the mixing chamber, and providing a mixer weight signal indicating the current weight of the mixing chamber.

A controller receives from an external source such as an operator, a liquid weight signal encoding the preselected liquid weight, a first particulate mass weight signal encoding the preselected particulate mass weight, and the mixer weight signal from the scale. The controller records the current weight of the mixing chamber as the first starting mixer weight, and then provides the first delivery signal with the second value thereof to the first delivery device. Then the controller periodically records the current weight of the mixing chamber, and responsive to the current mixer weight less the first starting mixer weight equaling or exceeding one of the preselected liquid and particulate mass weights, provides the first delivery signal with the first value thereof to the first delivery device

The controller also records the current weight of the mixing chamber as the second starting mixer weight, and provides the second delivery signal with the second value thereof to the second delivery device and periodically recording the current weight of the mixing chamber. Responsive to the current mixer weight less the second starting mixer weight equaling or exceeding the other of the preselected liquid and particulate mass weights, the controller provides the second delivery signal with the first value thereof to the second delivery device.

In this way, precise weights of these two ingredients are delivered to the mixing chamber.

Weight of a third ingredient loaded into the mixing chamber can be measured using the same mechanism. This makes the system particularly well suited for creating a gypsum slurry having preselected weights of water, gypsum powder, and sand as its ingredients.

### BRIEF DESCRIPTION OF THE DRAWINGS

These and other features and a more thorough understanding of the present invention may be achieved by referring to the following description and claims, taken in conjunction with the accompanying drawings, wherein;

FIG. 1 is a first side view of the portable cement mixing system of the present invention mounted on a flat-bed truck;

FIG. 2 is a detailed side view, similar to FIG. 1, of the portable cement mixing system of the present invention;

FIG. 3 is a detail side view, similar to FIG. 1, of the portable cement mixing system of the present invention showing different details of the invention;

FIG. 4 is a side elevational view of the crane;

FIG. 5 is a view illustrating the cement bin and auger;

FIG. 6A is a view illustrating an end view of the sand bin;

FIG. 6B is a view illustrating a side view of the sand bin;

FIG. 7 is a view illustrating an end view of the mixer;

FIG. 8 shows the side view of the mixer;

FIG. 9 shows the mixer outlet;

FIG. 10 shows the blender outlet;

FIG. 11 shows the blender;

FIG. 12 shows the end side view of the apparatus

FIG. 13 shows a cross-section of the blender;

FIG. 14 shows an end view of the blender and scales; and

FIG. 15 shows a list of activities for precisely controlling the ingredient proportions of a cementitious slurry.

FIG. 16 is a block diagram of a system for controlling operations pertaining to ingredient management and delivery of a cementitiuous slurry.

FIGS. 17A, 17B and 17C together comprise a flow chart for software or firmware executed by the system of FIG. 16 for controlling the ingredient proportions of a cementitious slurry.

FIG. 18 is a flow chart for software or firmware executed by the system of FIG. 16 for controlling the delivery of a cementitious slurry to a job site.

### DETAILED DESCRIPTION OF THE INVENTION

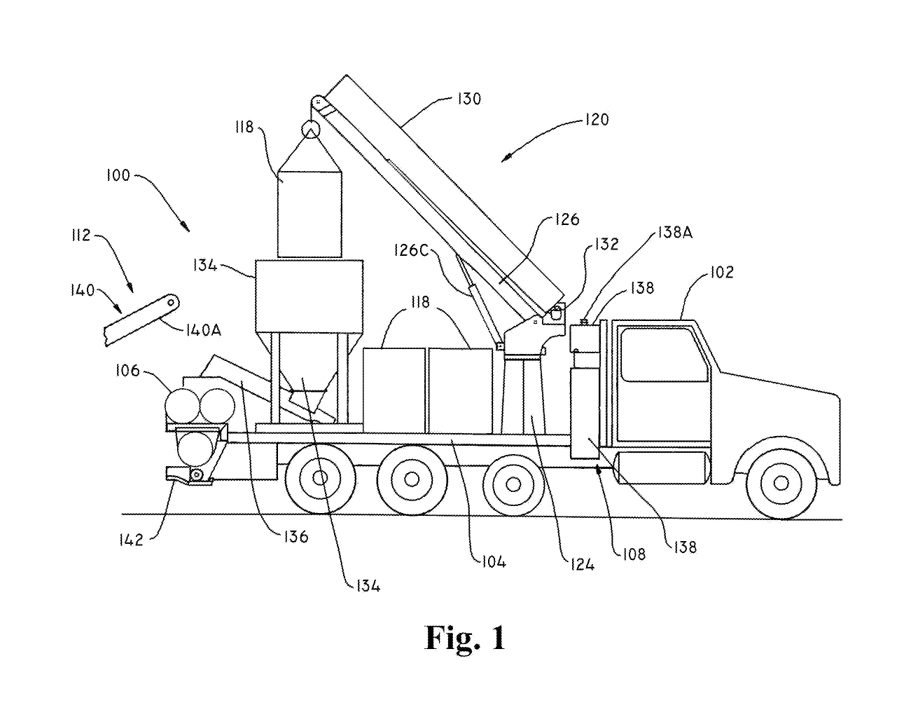

FIGS. 1, 2 and 3 show the major elements of portable mixing system 100 mounted on a motorized vehicle 102. Vehicle 102 has a bed 104 on which in mounted mixing system 100 for easy transport to any desired job site. Mixing system 100 may also be mounted on a trailer for towing to the job site.

These arrangements provides mobility for system 100. Either arrangement permits cement mixing system 100 to be transported to a construction site, where the ingredients of a cementitious slurry can be measured and mixed for placement at the desired site. “Cement” refers here to both gypsum powder used to form gypsum underlayer and to Portland cement, used to make concrete.

System 100 delivers accurately measured weights of water, cement, and sand to a mixer 106. Water stored in a tank 138 on vehicle 102 passes through a pipe or hose 128A to a hydraulically operated pump 128B. Another pipe or hose 128D carries water from pump 128B to mixer 106. Pump 128B may be considered a delivery device for the water required for the slurry to be formed. If flow of water is under control of a valve, then that valve would be a delivery device.

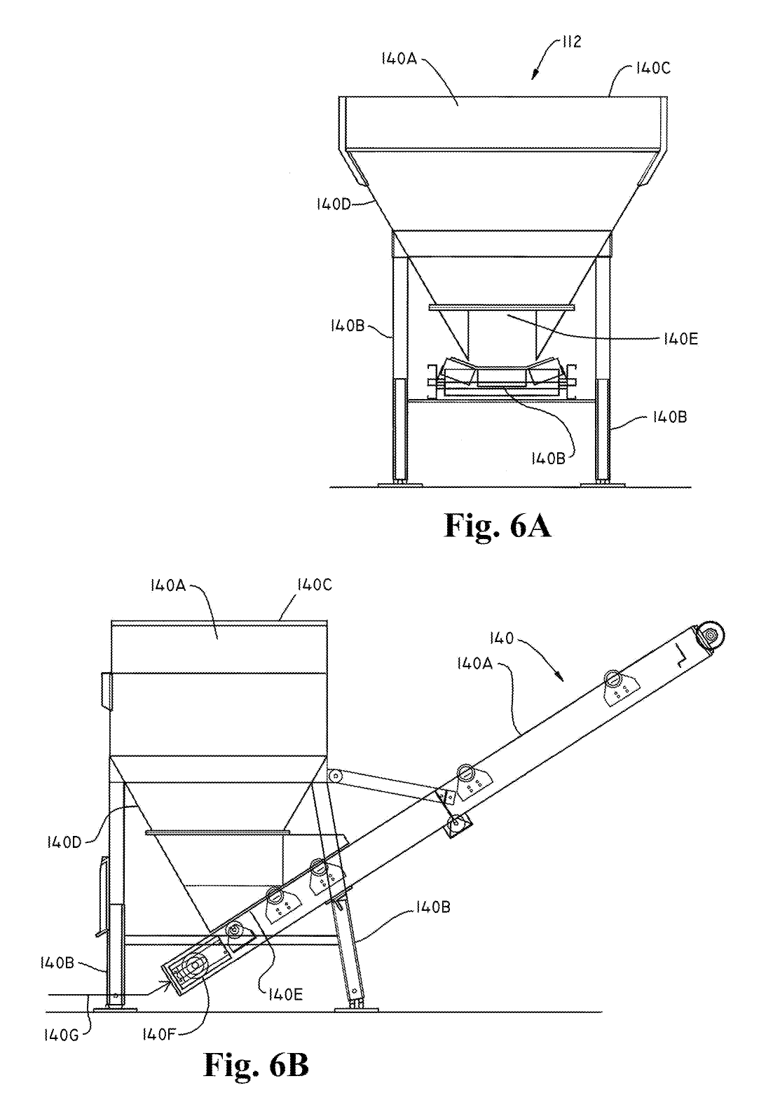

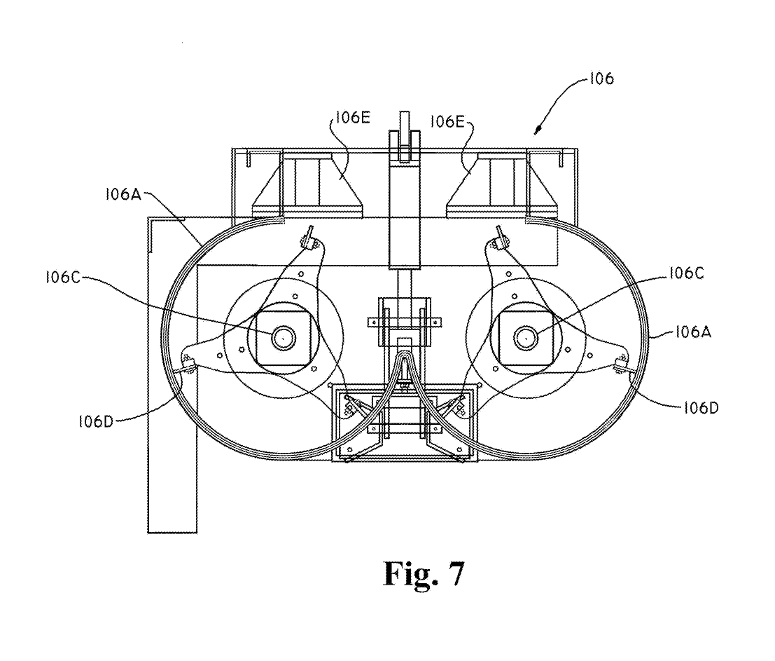

Vehicle 102 includes a hydraulic pump 103 driven by the engine of vehicle 102 that supplies pressurized hydraulic fluid through a hose 105 for operating the motor 136B that drives a cement auger 136 and a motor 140F (FIG. 6B) that drives a sand conveyor 140. Auger 136 and sand conveyor 140 and their cooperating element may also be considered delivery devices for the cement and sand ingredients of the slurry for system 100 to form.

Pump 103 also provides pressurized hydraulic fluid for other devices forming a part of system 100. Valves to be described later control the flow of the pressurized hydraulic fluid to motors 136B and 140F and to these other devices.

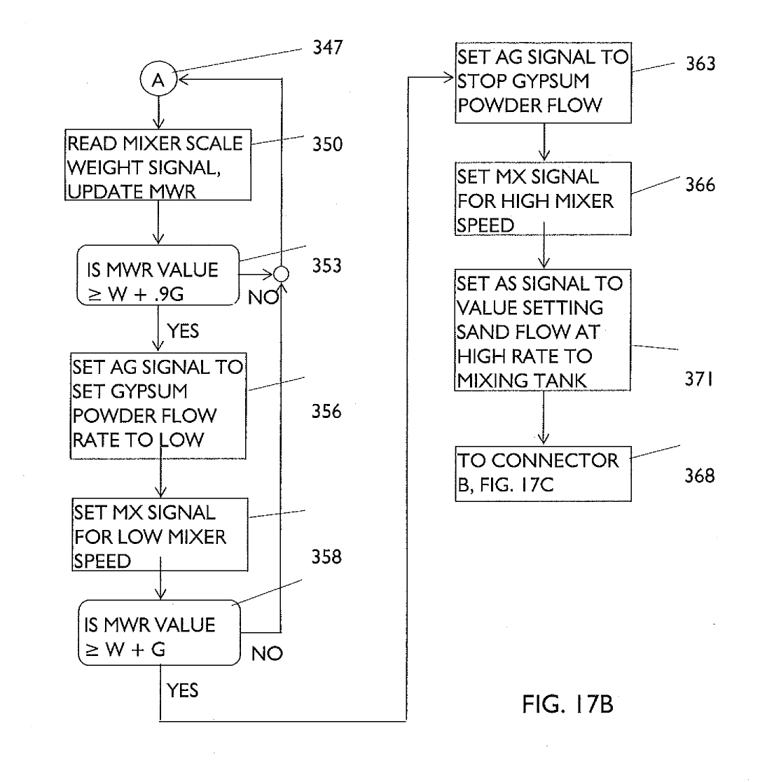

Controller 116, shown in more detail in FIG. 16, provides control of system 100. Controller 116 includes all the components and capabilities of current general-purpose computers including a keyboard 116A, display 116B and printer 116C. Keyboard 116A permits the operator to enter a variety of inputs to the apparatus in the field. Display 116B permits the operator to observe the various operating parameters and printer 116C permits generating a permanent record of selected results during the operation of the apparatus.

Keyboard 116A can be used to input cement mixing parameters and other requirements and data. The parameters and data can relate to the hardness of the concrete, the weights of the various ingredients or any other parameter. Controller 116 is linked with, and individually controls, all operations of the apparatus.

Controller 116 has a mixing control program stored in memory that orchestrates the operation of the entire system in response to stored cement mixing parameters and various measured information. This information permits controller 116 to precisely control the apparatus and also permits avoiding potential problems in the operation of the system, described hereinafter.

The system operation can be initiated either manually by keyboard or by calling up a previously prepared and entered program, either of which provides data to controller 116 giving the desired concrete characteristic requirements. This includes the amounts of the various ingredients for the specified concrete characteristic.

A setup mode of operation for controller 116 may prestore the various cement mixing parameters, formulae, processes, and related ingredient weights. These various formulae can be selected by the operator in the field by relatively simple keyboard entries. An alternate mode of operation permits the operator to change any or all of the above parameters in the field relating to different formulae by keyboard entries using interface 116A. While more time consuming, this has the advantage of permitting use of the mixing system 100 for any operation within its operating range regardless of previously prestored data. This addition provides maximum flexibility in the field.

Controller 116 interprets this data using the active program to determine the amount of weight of the various ingredients needed for each ingredient to achieve the desired hardened product characteristics. Using this approach the total will then indicate only the weight of the currently transferred ingredient and will be interpreted in that manner.

All of the ingredients are mixed together in mixer 106, described below. Mixer 106 mixes the various ingredients in the mixer for a predetermined period of time set by controller 116 and the mixing control program. In one method, the quantity of each ingredient is determined by weighing mixer 106 immediately before and while the ingredient is conveyed to the mixer 106. Determining the weight of mixer 106 and its contents before the new ingredient is added and then subtracting their weight during the transfer will determine the amount of the ingredient that has been transferred. When the required weight of a given ingredient has been added, controller 116 stops that particular conveyor from conveying any more of that particular ingredient to mixer 106. Typically, controller 116 directs mixer 106 to commence mixing when the required amount of water has been added to mixer 106. Mixing continues while the other ingredients are added to mixer 106. After the ingredients have all been added, further mixing for a predetermined time occurs until controller 116 sends a stop signal to mixer 106.

Mixing system 100 and controller 116 can also be configured to perform a number of other complementary activities. As one example, controller 116 may provide a signal that indicates the completion of mixing to the operator. This signal could include an audible signal, or a visual sign such as a light turning on, and similar arrangements. These are representative of the variety possible other responses.

Controller 116 interfaces with all operating elements and precisely regulates the weight of any given ingredient (e.g., cement, water, sand, etc.) introduced into mixing system 100 as well as the various operating times and/or conditions.

Controller 116 also monitors various parameters relating to the ongoing system status to avoid potential problems. This includes such things as monitoring the quantity of slurry in a blender 108, described later. Mixer 106 transfers the mixed slurry from mixer 106 to blender 108 for further blending, and more importantly, for temporary storage or buffering, the flow of slurry to the placement site. Weight measuring means, described later, determines the weight of blender 108 and its contents to both avoid overfilling or underfilling. Controlling the weight of slurry in blender 108 avoids problems of spillage caused by overfilling and pumping problems arising from underfilling.

Turning to FIG. 16, controller 116 therein is a data processing device such as a personal computer. Appropriate connections between controller 116 and various elements of the described apparatus tie the entire mixing system 100 together to permit controlling various operations of the system.

The block diagram in FIG. 16 for controller 116 shows major functional elements and the relevant signals supplied to and by controller 116 for controlling the operation of system 100. It is conventional knowledge that computers comprise electrical circuits. As such, the portion of the invention that the controller 116 comprises is simply a complex electrical circuit the uses software or firmware to modify and control operations to provide the required functionality.

One may consider the circuitry of controller 116 while executing the various instructions for controlling system 100, as sequentially becoming one and then another of the various functional elements shown in FIG. 16. Thus, these functional elements typically exist sequentially rather than simultaneously, but that does not matter for purposes of defining the invention in apparatus claims.

One should also note that the instructions for controller 116 are held in a physical memory 116F. These instructions themselves create a unique physical structure in memory 116F, in that the bytes comprising the instructions cause physical alterations of the memory cells themselves. Granted, the changes are sub-microscopic, but the patent law imposes no size limit on the subject matter of an invention. Thus, this programmed controller 116 is simply a complex machine and should be considered as such when evaluating claims addressing the control functions of controller 116.

As previously mentioned, controller 116 comprises the standard components for a computer: control element 116D, display element 116A, keyboard 116B, and memory 116F. Controller 116 also has communication functionality allowing sending and receiving of signals from external devices. Memory 116F stores the various instructions that configure controller 116 as the various functional elements needed to operate system 100. Memory 116F includes as one element of the invention, a mixer weight register (MWR) 116G that stores the current weight of mixer 106. Memory 116F also includes as a further element of the invention, a blender weight register (BWR) 116H that stores the current weight of blender 108. Registers 116G and 116H are of course physical structures within memory 116F.

Mixer weight monitor 116C and blender weight monitor 116E are two functional elements shown as a part of controller 116 in FIG. 16 and that form a part of the invention. Weight monitors 116C and 116E actually are integral with control element 116D, and exist only during the time that instructions specific to the stated weight monitor function execute within control element 116D.

Controller 116 uses the communication functionality to provide a water start/stop signal AW on a data path 108A, a cement powder delivery fast/slow/stop signal AG on a data path 108B, and a sand delivery fast/slow/stop signal AS on a data path 108C. The AW, AG, and AS signals control the delivery of these masses in terms of speed at, and time during, which the specified ingredient is loaded into mixer 106.

As stated, mixer weight monitor 116C comprises a functional element of controller 116, and receives on paths 107A and 107B, MW₁ and MW₂ signals from scales 106E. The MW₁ and MW₂ signals encode the weight of mixer 106. Scales 106E support mixer 106 and provide the MW₁ and MW₂ signals. Scales 106E may comprise commonly available electronic load cells. Mixer weight monitor 116C uses the MW₁ and MW₂ signals to continuously calculate the actual current weight of mixer 106, and store that weight in MWR 116G.

Three different delivery means provide the different ingredients to mixer 106. The ingredients for this embodiment include cement powder (previously defined as gypsum or Portland cement), water, and sand. Controller 116 directs the delivery means to provide the ingredients in the proper weights and order to mixer 106 where they are mixed together. Controller 116 interfaces with and controls the operation of, mixer 106 and the various ingredient conveyors. Controller 116 controls each conveyor device sequentially and determines that the required quantity of each ingredient is transferred to mixer 106 as previously described.

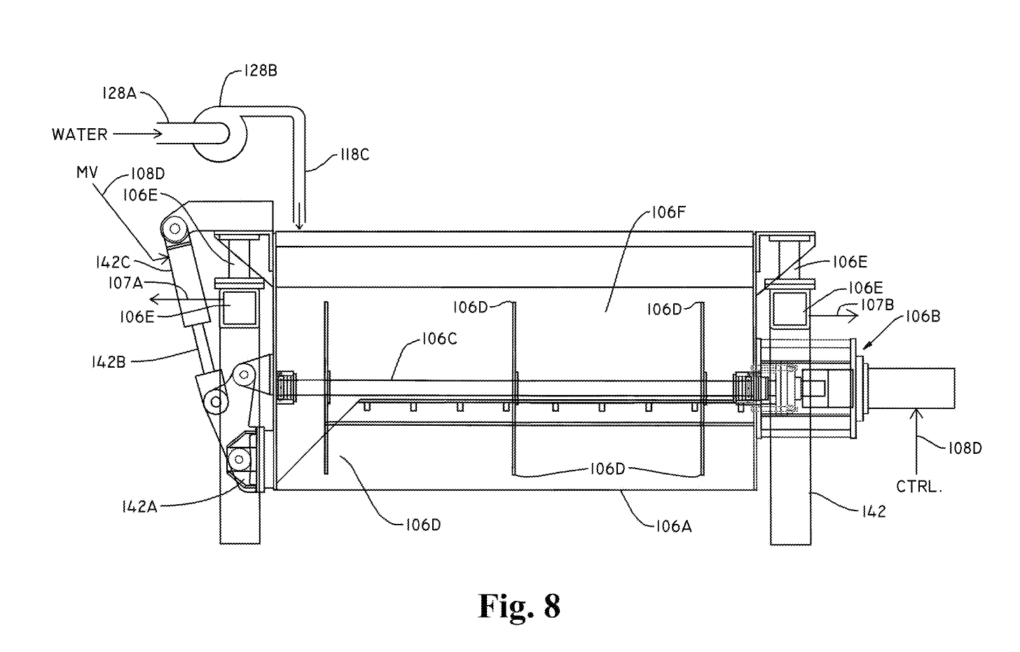

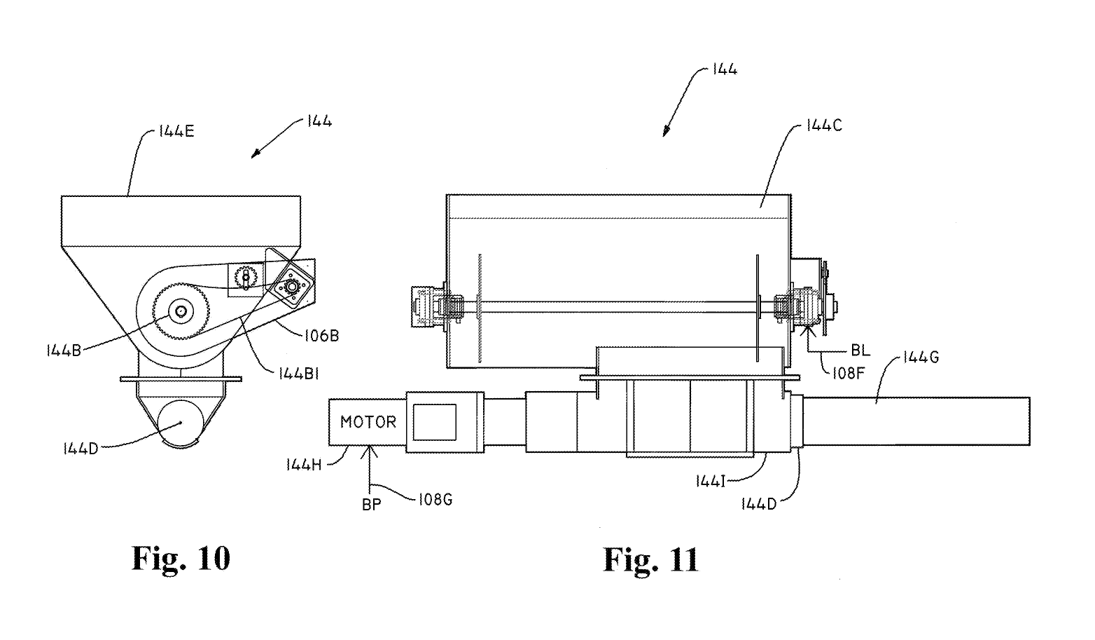

Mixer 106 is shown in FIGS. 7-9. Here various ingredients are mixed together within two interfacing cylindrically shaped segments 106A which together form a double drum housing having a 10 cubic foot capacity.

Two rotors 106C, one located within each segment 106A, are each powered by a hydraulic motor 106B attached to one end of each rotor. Each rotor 106C has three equally spaced outwardly extending paddles 106D which counter rotate relative to an adjacent rotor to completely mix any ingredients located within interfacing drum segments 106A. Interfacing drum segments 106A contain a volume of about 10 cubic feet. While motors 106B operate hydraulically using power provided by vehicle 102, other power sources and motor types can be employed.

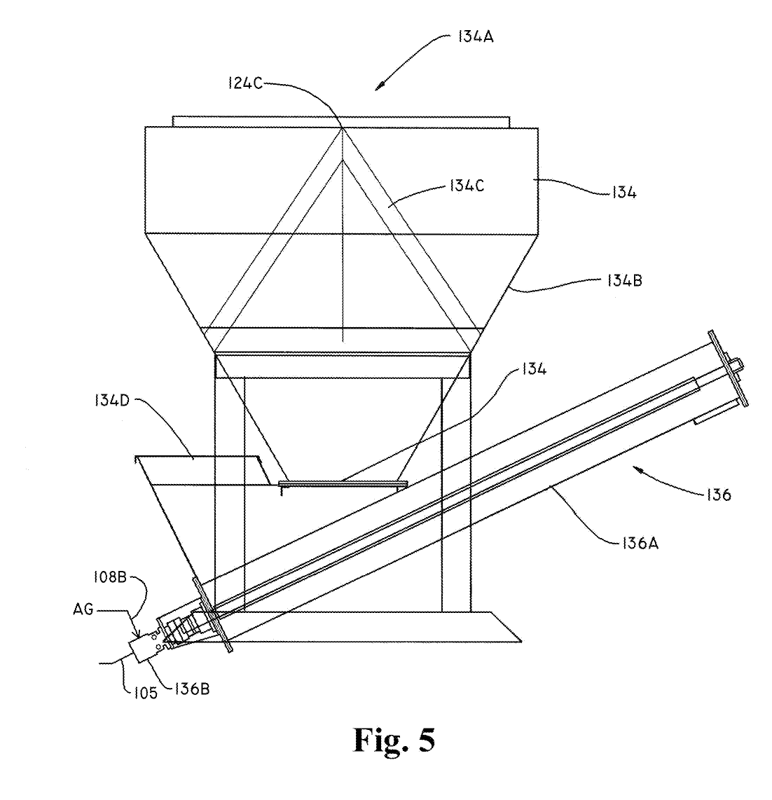

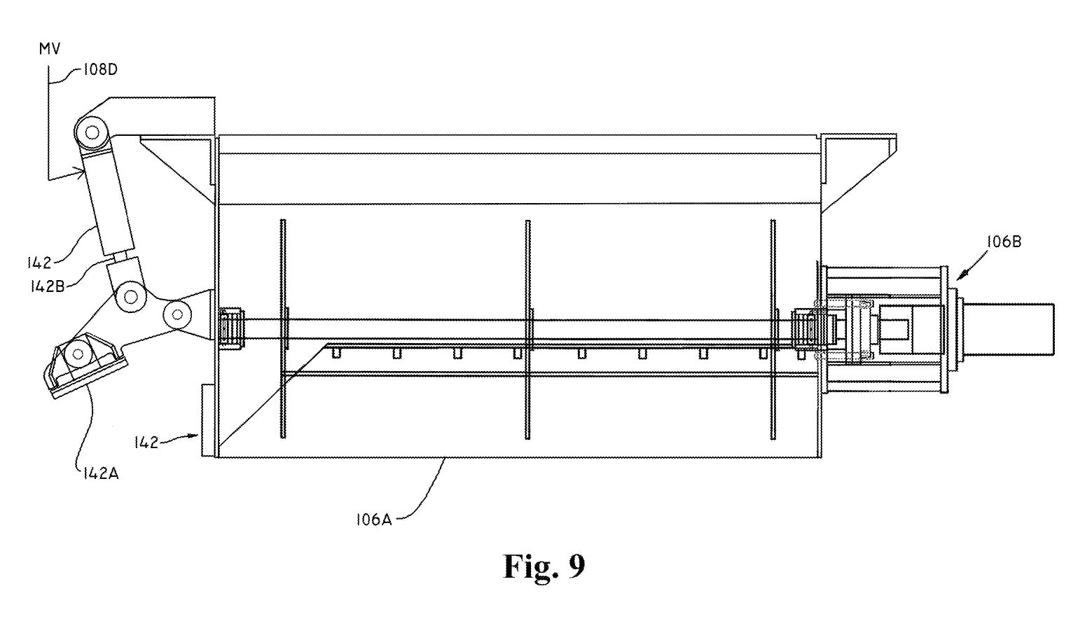

Conveyors 136 and 140 (FIGS. 5 and 6B), described hereinafter, transport their respective ingredients into the open top of mixer 106. FIG. 8 shows the two supporting scales 106E located at opposite ends of mixer 106 for monitoring mixer 106 weight. With this arrangement, scales 106E form weight sensing means for measuring the weight of mixer 106 and any ingredients within segments 106A. Scales 106E send their outputs on signal paths 107A and 107B to mixer weight monitor 116C, which interprets the mixer weight signals and stores the latest mixer weight in memory 116F at the MWR location 116G.

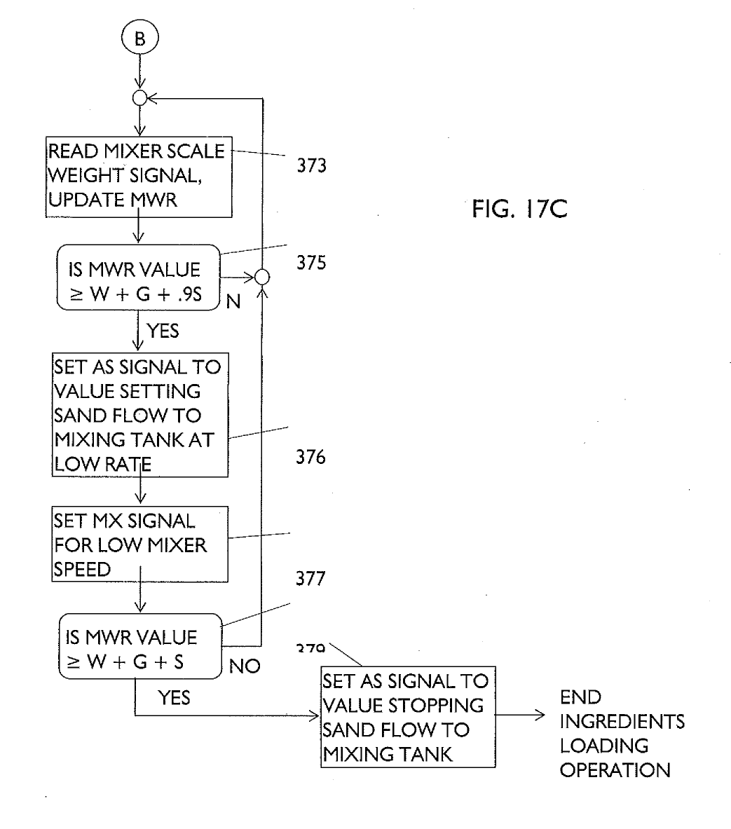

As will be explained in connection with the flow chart of FIG. 17, controller 116 monitors the weight of mixer 106 while ingredients are added. Recording (or zeroing) the starting weight held in MWR location 116G, and then monitoring the current weight of mixer 106 while an ingredient is added, allows the weight of this ingredient in mixer 106 to be determined in real time. When the required weight of an ingredient has been added to the mixer 106, control module 116D halts flow of the ingredient to mixer 106 on the pertinent one of signal paths 108A, 108B, or 108C.

The MX signal on path 108E from control element 106D controls mixer operation. The MX signal has in this embodiment, three values that cause mixer 106 to mix either fast or slow. Stopping the mixer 106 is normally under manual control.

After adding the ingredients and the mixing of them is finished, the slurry is ready for dispensing. Mixer 106 has an outlet 142 allowing the contents of mixer 106 to empty into a blender 144. A cover 142A operated by a hydraulic cylinder 142C with a ram or piston 142B, opens and closes outlet 142. With piston 142B extended from cylinder 142C as shown in FIG. 8, cover 142A seals mixer outlet 142 preventing slurry flow from mixer 106. When cylinder 142C retracts piston 142B, outlet 142 opens to allow slurry flow into blender 144. Outlet 142 is on the low side of mixer 106, thereby permitting slurry to flow under gravity from mixer 106 through outlet 142 into blender 144.

The MV signal on path 108D from control element 106D sets the position of piston 142B. In the simplest type of control, control element 106D simply holds outlet 142 either open or closed. In this way, control element 106D can control the flow of slurry from mixer 106 into blender 144, and the slurry level in blender 144.

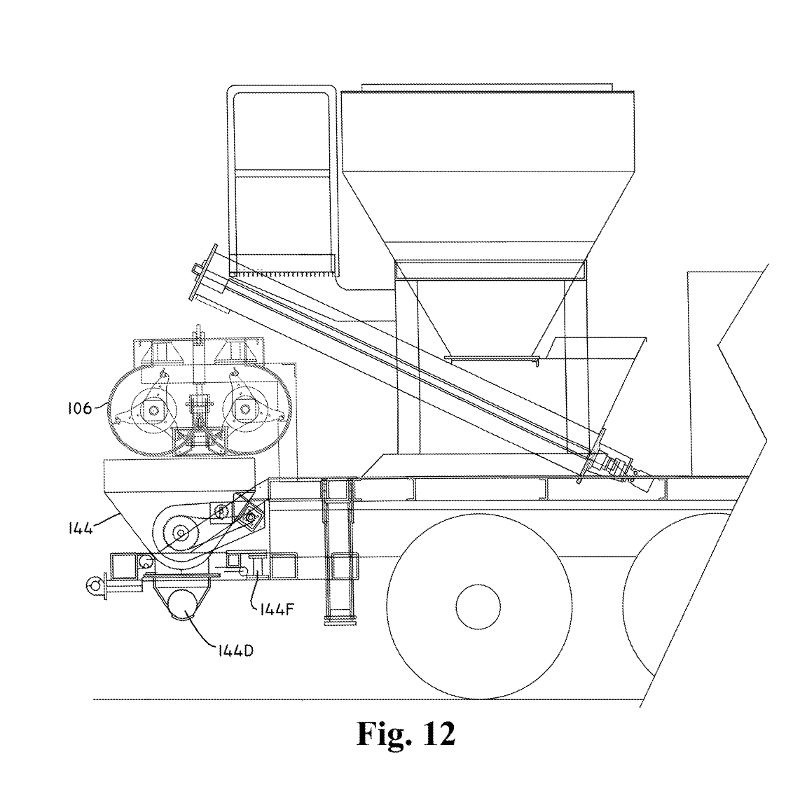

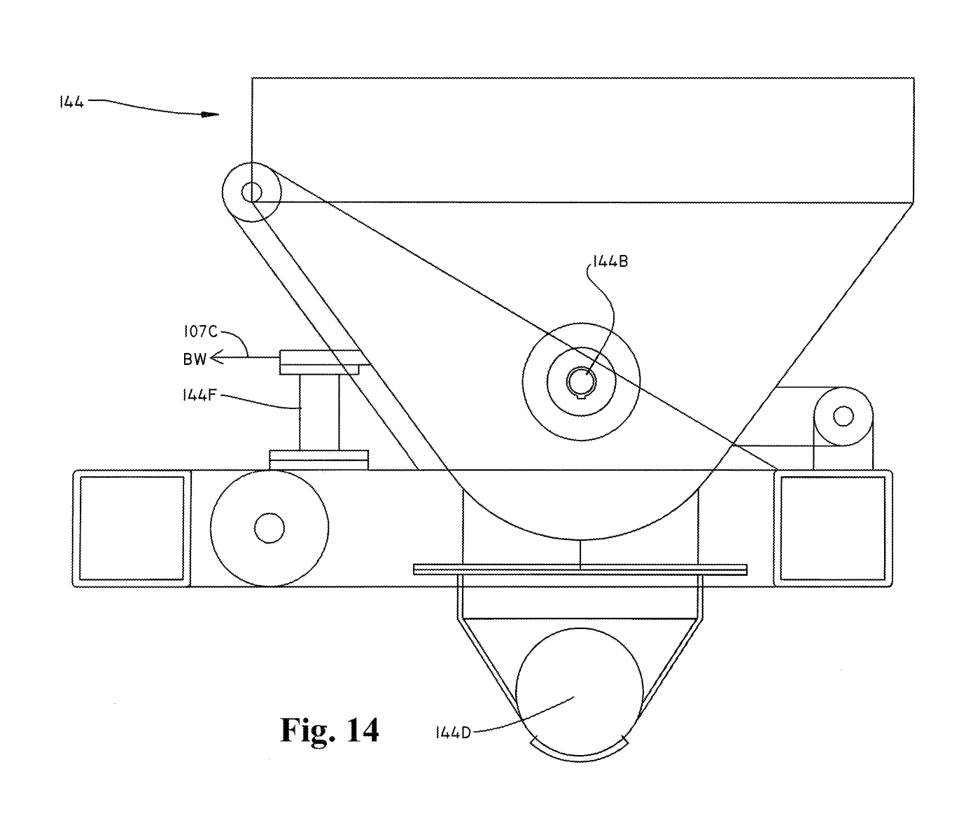

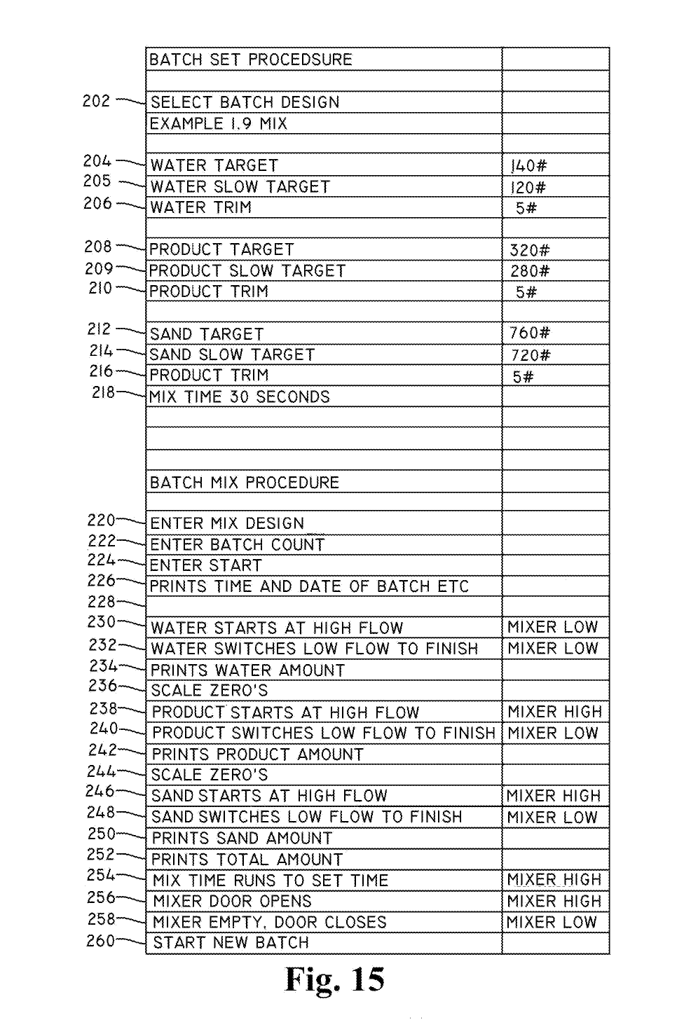

Blender 144 is shown in FIGS. 10-14. Blender 144 comprises a hopper for holding slurry temporarily until delivered for placement. Blender 144 receives the slurry mixture flow from mixer outlet 142 into an upper opening 144E when cover 142A of mixer 106 is moved from outlet 142. Blender 144 has a hydraulic motor 144A that drives a shaft 144B by chain 144B 1 to rotate paddles 144C to further stir the slurry to keep it fluid and the solids properly suspended. Motor 144A operates under control of a BM signal on path 108F that has a first value that commands motor 144A to turn paddles 144C rapidly, for slow turning of paddles 144C, and a third that stops paddles 144C.

The slurry exits through outlet 144D propelled by motor 144H driving a pump 144G which delivers the slurry to the emplacement site through a hose or other conduit 144G. Controller 116 provides a BP signal on path 108G. The BP signal has a first value that enable pump 144G to operate under control of the person who is directing the delivery of slurry to the point of deposition. When slurry is needed for deposition that person can use a separate control (not shown) for activating pump 144G. A second value of the BP signal disables pump 144G.

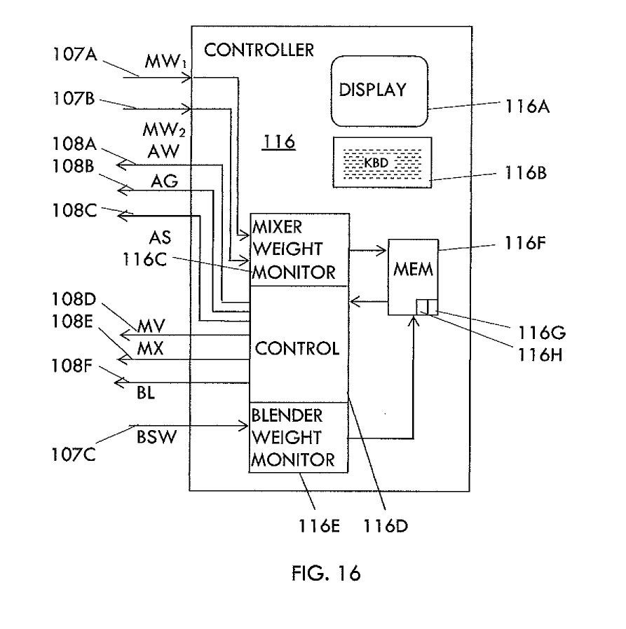

An electronic scale 144F is arranged to determine the weight of blender 144 and its contents. Scale 144F provides a blender weight signal BW on a signal path 107C to the blender weight monitor 116C, see FIGS. 14 and 16.

Controller 116 operates cover 142C, scale 144F, and pump 144G to assure that the level of slurry in blender 144 does neither overflow nor fall so low that air can enter pump 144G. Controller 116 further operates to prevent pump 144G operation when no more slurry is available in mixer 106 and the level of slurry in blender 144 will allow air to enter pump 144G.

As shown in FIGS. 1-3, a water supply system 128 provides water to mixer 106. Water supply system 128 includes a reservoir 138 with a 200 gallon capacity, for example. It is coupled to mixer 106 through pipe 128A, pump 128B, and pipe 128C. Cap 138A, which mates with an opening on the top of reservoir 138, provides an upper opening for filling the reservoir.

Water pump 128B uses hydraulic power to pump water from reservoir 138 to mixer 106. A water pump control (W) signal is carried from control element 116D on a signal path 108A to control the operation of pump 128B. In one embodiment, the W signal may have three levels, pump 128B fast, pump slow, and pump off when operating to supply water to mixer 106. In this way control element 116D can turn pump 128B on and off and control the rate at which water is added to mixer 106.

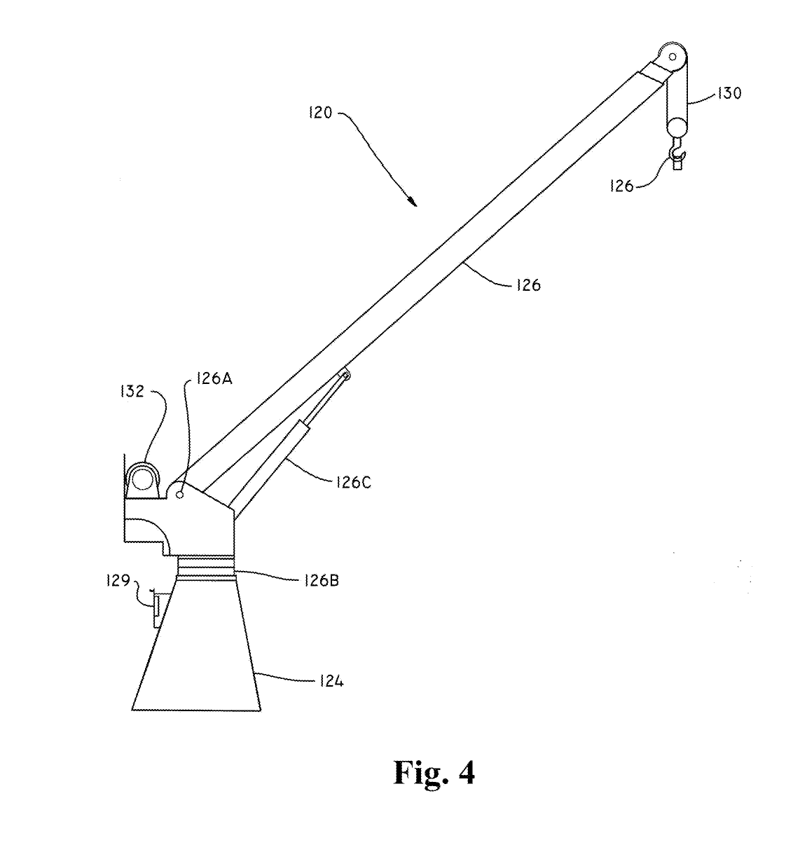

Cement handling device 120 shown in FIG. 4, transfers cement from cement bags 118 to cement bin 134 prior to operating the apparatus to load mixer 106. Cement handling device 120 transports individual cement bags 118 from bed 104 to cement bin 134. Cement bags 118 are conventional cement bags, each containing a predetermined amount of mixing-ready gypsum or Portland cement powder. Bags 118 are positioned on bed 104 in a location accessible by crane 126, as described hereinafter.

As described hereinbefore, device 120 pre-loads bin 134 with bags 118 stored on bed 104 before operating mixing system 100. Device 120 has a base 124, a boom 126 and a two axis boom controller 129. The functions of device 120 can be performed, for example, by the Auto Crane, model 8406H telescoping crane.

Boom 126 can be inclined to different angles around generally horizontally oriented pivot axis 126A by a hydraulically powered cylinder 126C and slewed hydraulically by rotating mount 126B under manual control using two axis controller 129. Pump 103 provides pressurized hydraulic fluid to operate crane 120. Inclining boom 126 at varying angles changes the horizontal spacing of the object being transported by device 120 from mount 126B. These two degrees of freedom of movement of the boom 126 with respect to bed 104 permits the boom to transfer cement bags 118 both on and off bed 104 of vehicle 102 to cement bin 134.

Boom 126 has on the end thereof, a line 130 which suspends each cement bag 118. Line 130 may be rope, metal wire, polymeric fibers, or any other material capable of extending from the boom 126 and securing a bag 118 and having the necessary strength to support the bag. A proximal end of line 130 opposite bag 118 is wound about a spool 132 driven by a hydraulic motor to extend or retract the line 130. The opposite, distal end of line 130 terminates in hook 126C. Any other arrangement that can readily capture a concrete bag 118, however, can be used. Valves control the flow of hydraulic fluid for operating cylindrical 126C and slewing boom 126.

While device 120 is shown as using a boom for lifting and carrying bags 118, other mechanisms capable of providing the desired two degree of freedom movement for bags 118 may also provide this function.

Cement bin 134, shown in FIG. 5, can have a capacity of 70 cubic feet. Cement bin 134 has a rectangular upper opening 134A, and the cross-rotational area is gradually reduced downwardly along tapered portion 134B. Upward opening 134A is located and oriented to receive the contents of a cement bag 118 transported by boom 126. A bag 118 is positioned above upward opening 134A and lowered into the opening 134A where the bag is cut open by the inverted V structure 134C. The contents of bag 118 then fall into cement bin 134. Bin 134 should be loaded with as many bags 118 as necessary for the next slurry batch. Cement bags 118 can, alternatively be loaded for transfer to mixer 106 through an optional port 134D.

Cement bin 134 works in conjunction with a cement conveyor 136 to transfer cement from bin 134 to mixer 106. Conveyor 136 is shown as having a rotating auger 136A that moves the cement from bin 134 to mixer 106.

Auger 136A is powered by a hydraulic motor 136B with oil from pump 103 supplied by hose 105. An AG signal, see FIG. 5, provided by control element 116D to motor 136B, governs the speed of motor 136B. In one embodiment, the AG signal can specify fast, slow, and stopped operation for motor 136B. The AG signal may operate a valve for example that controls flow rate of hydraulic fluid from hose 105 to hydraulic motor 136B. While conveyor 136 is shown as utilizing an auger 136A to transfer cement to mixer 106, any other appropriate apparatus and power source capable of transporting cement from bin 122 to mixer 106 can be utilized.

As shown in FIGS. 1-3, a water supply system 128 provides water to mixer 106. Water supply system 128 includes a reservoir 138 with a 200 gallon capacity, for example. It is coupled to mixer 106 through pipe 128A, pump 128B, and pipe 128C. Cap 138A, which mates with an opening on the top of reservoir 138, provides an opening for filling the reservoir.

Hydraulically powered water pump 128B pumps water from reservoir 138 to mixer 106. The water (AW) signal is carried from control element 116D on a signal path 108A to control the operation of pump 128B. In one embodiment, the AW signal may have three levels, pump 138C fast, pump slow, and pump off when operating to supply water to mixer 106. In this way control element 116D can turn pump 138C on and off and control the rate at which water is added to mixer 106.

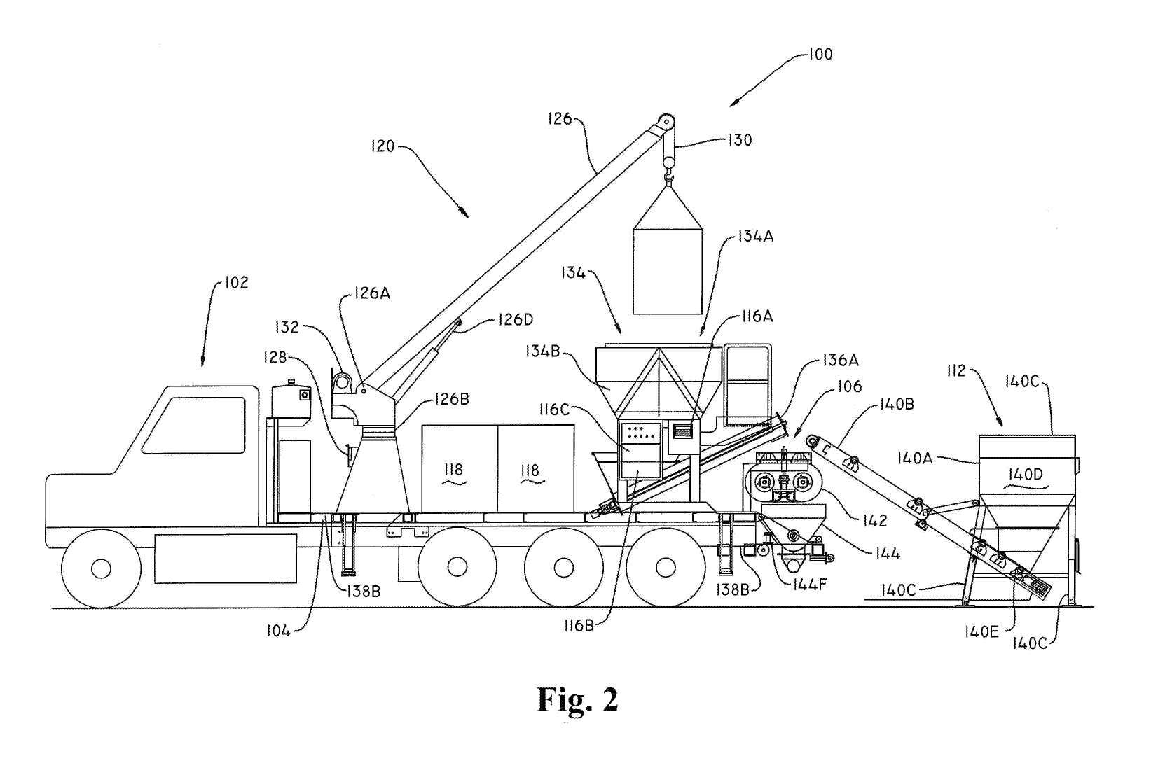

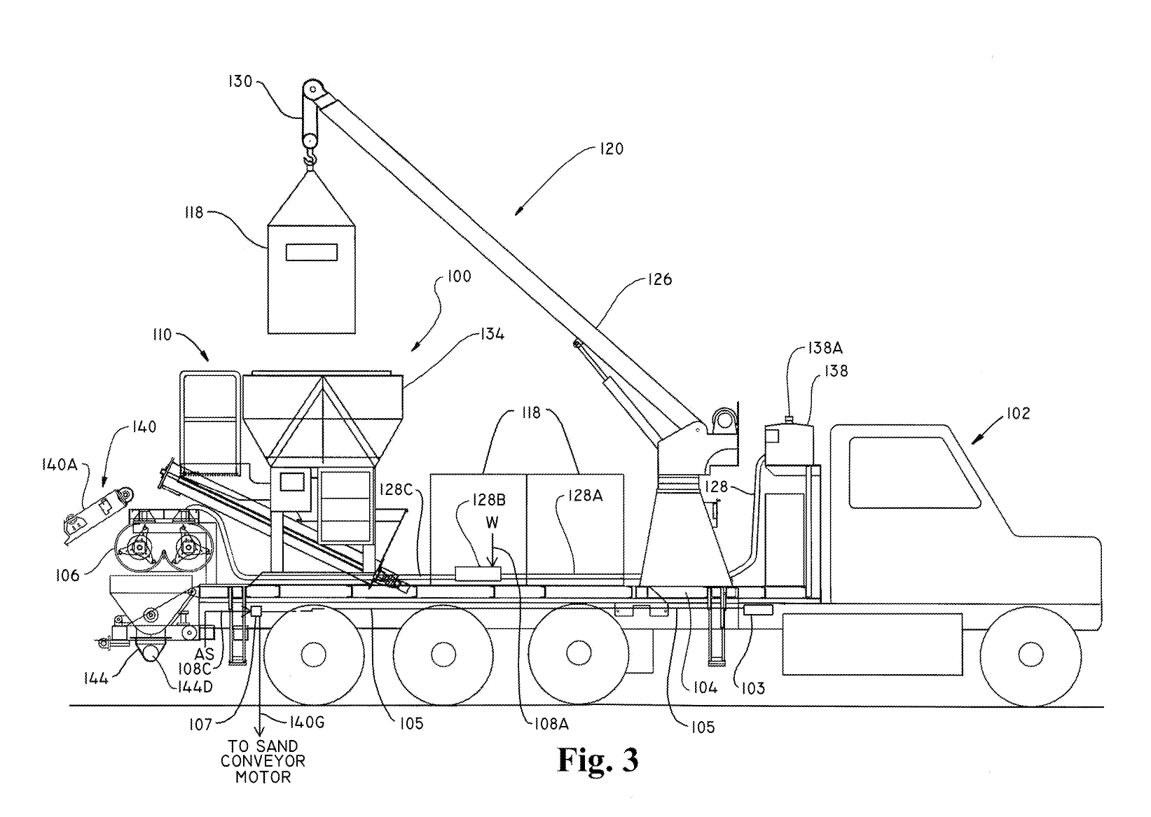

Sand conveyor system 112, shown as part of an overall system in FIGS. 2 and 3 and shown separately in FIGS. 6A and 6B, is used to transfer sand or a similar ingredient and/or filler (e.g., crushed limestone, gravel, crushed recycled concrete, or similar material) to mixer 106. Sand conveyor system 112 includes a sand bin 140A that in the embodiment shown is detached from vehicle 102. Sand bin 140A is mounted on four legs 140B and may have a capacity of 125 cubic feet.

Sand bin 140A has an upper opening 140C with downwardly and inwardly inclining sides and a bottom opening 140E. A conveyor arm 140 extends from below the bottom opening 140E to above upper mixer opening 106F. Conveyor belt 140B extends along the length of arm 140 from one end to the other and is driven by a hydraulic motor 140F mounted at the bottom of arm 140 at a speed set by the AS signal. In the embodiment shown, motor 140F has fast and slow speeds and a stopped mode, specified by fast, slow, and stop values for the AS signal.

Motor 140F drives the belt in the direction which will convey sand from below sand bin 140A to above mixer 106. The sand reservoir is shown located adjacent vehicle 102, but it could be mounted on bed 104 of vehicle 102. Vehicle 102 carries a valve 107 (see FIG. 3) that receives the AS signal on path 108C from control element 116D. The AS signal controls the setting of valve 107 to set motor 140F speed at either the fast or slow speed, or to stop motor 140F.

If conveyor 140 is of the type that is detached from vehicle 102, then a detachable hydraulic hose 140G connects from a hydraulic valve 107 to motor 140F. Signal path 108C carries the start/stop signal S to motor 140F. In this way, controller 116D can turn the motor 140F on or off as required to transfer the amount of sand required by the program and as measured by scales 106E.

Printer 116C can be used to record all relevant parameters during system operation for the particular mixture being produced by mixing system 100. This record can include all of the above data fields and all related concrete parameters. For example, these records can including the date and selected time intervals to record the date, the water weight, the cement weight, the sand weight or any other relevant system parameters.

System 100 can be configured to permit introduction of additional ingredients into the mixture for other products. These can include such things as fly ash, super elasticizers, retarding admixtures, accelerating admixtures, and other ingredients related to the particular product being produced.

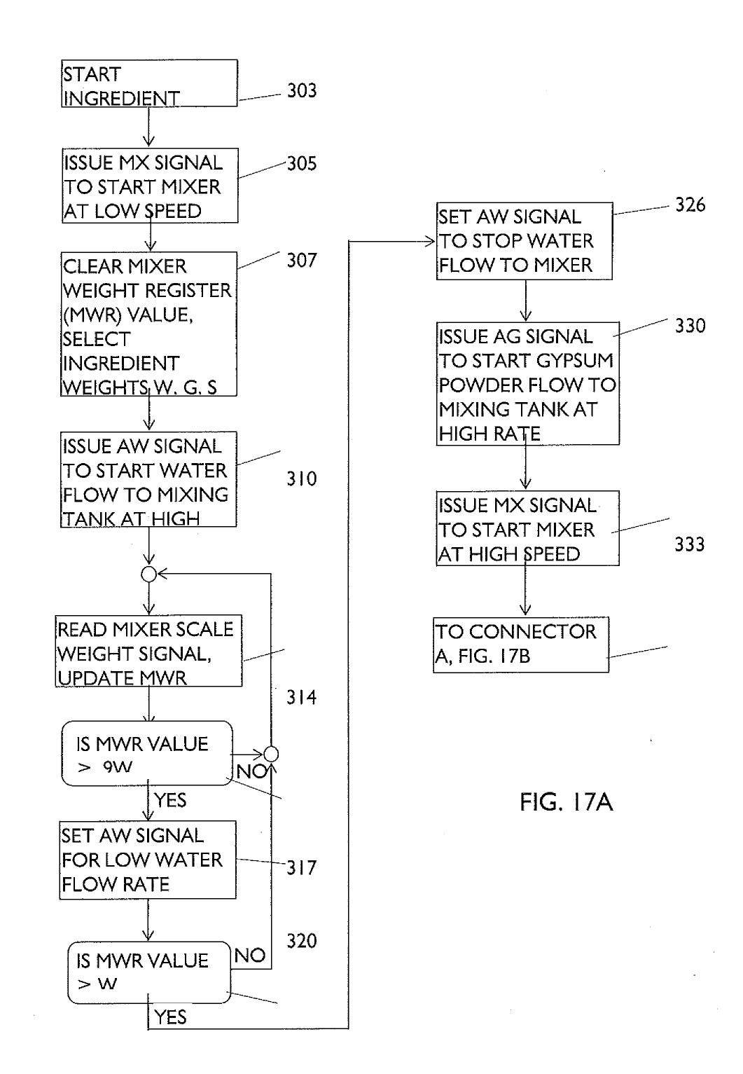

FIG. 15 is a chart which illustrates the sequence of a typical procedure for a cement mixing method in accordance with the present invention. Alternatively, the various target weights can be given. Such an alternative method essentially mirrors the procedures shown in FIG. 15.

The Batch Set Procedure begins at 202 of FIG. 15, the Select batch design step, Example 1.9 mix. In this step the user inputs desired concrete characteristics data into the system controller 116 using keyboard 116A. Controller 116 interprets this data to determine the required weight of each ingredient. In accordance with one example, the program requires that the final concrete product have a hardness of 2,500 psi. Based on such a requirement, controller 116 calculates predetermined volumes for all of the required ingredients. In the example, these ingredients are, sequentially, water, the cement product and sand. Controller 116 then converts the volumes calculated into a weight for each ingredient. An inflow rate of water is initiated based upon target weight for the initial water component. This initial flow rate is followed by a slow target rate where the ingredient is fed into the mixer at a slower rate to avoid an excessive amount being introduced. This is followed by the trim weight rate of flow necessary to achieve the final required weight. The target weight, slow target weight and trim weight are shown successively for water 140#, 120# and 5#. The flow rates for a cement product are 320#, 280# and 5#, and for sand are 760#, 720# and 5#.

A required mix time of 30 seconds, for the example, is also determined by controller 116. These weights and mixing time are merely by way of example and are different for other types of concrete.

Batch Mix Procedure begins at an Enter mix design step. Prior to this procedure, a cement bin 134 has been loaded with cement typically by using crane 120 which has been employed to transfer cement bags 118 from bed 104 to cement bin 134. Bags 118 are automatically opened by knife 124C. Sand bin 140B has also been loaded with sand. Sand conveyor system 112 has been positioned as shown in FIGS. 1-3. Water reservoir 138 has been filled with water prior to initiation of water flow into the mixer 106 in accordance with step 202.

The Batch Mix Procedure begins the process. Enter mix design, and Enter batch count by controller 116 are followed by Enter start, which begins the process. The next step, Prints time and date of batch etc., is documented by printer 116C for the record. The scale zero's step subtracts any reading attributable to the mixer scales 106E in order to weigh only the added ingredient. The steps follow such that, as previously described, water starts at high flow and the mixer speed is low. The water switches to low flow until the target amount is reached, and the mixer remains at low speed. Water amount is printed using printer 116C. The scale zero's step then follows. The product starts at high flow with mixer at high speed. The following steps are then sequentially performed:

Product switches to low speed to finish with mixer low.

Product amount is printed using printer 116C.

Scale zero's.

Sand starts at high flow with mixer at high speed.

Sand switches to low flow to finish with mixer speed low.

Sand amount is printed using printer 116C.

Prints total amount of ingredients by summing the individual ingredient weights.

Mix time runs to set time with the mixer speed high.

Mixer door opens with the mixer speed high.

Mixer empty, door closes with the mixer speed low. The determination of when the mixer is empty is also determined by the mixer weight scales 106E.

Start new batch.

After cement has been conveyed to bin 122, it is then transferred to the mixer 106 by auger 136, as at step 208. After the required amount of cement has been transferred as indicated by the data from scales 106E at step 210, weight is determined by the controller 116. Until the required amount of cement has been transferred, the method 200 continues step 208 until the correct weight has been attained. Once the required amount of cement has been introduced, the method 200 continues with step 212. Water is transferred from the reservoir 138 to the mixer 106. Again, before step 214 has been performed, step 212 is continued. After the required amount of concrete has been added, step 216 is entered and sand is then added to mixer 106. Again, before step 218, step 216 is continued until the required amount of sand has been added. Once the required amount of sand has been added, mixer 106 mixes the ingredients in step 220. After mixer 106 has mixed the ingredients for a predetermined length of time, step 222 is then entered and pourable concrete is output to blender 144.

Note that the method described hereinbefore is merely representative of one way of programming controller 116. Depending upon the particular type of cement, the ingredients required, the various mixing times, the method of determining the quantity of the ingredient being transferred and the specific hardness, different programs could be employed. The ability of controller 116 to coordinate an essentially unlimited variety of requirements quickly and accurately by merely using a different program gives this apparatus great flexibility.

Keyboard 116B is provided, as shown, as an operator interface to permit the entry of pertinent information in the field. This could be supplemented by a touch screen or a specialized interface that permits input of only certain data fields such as concrete hardness, concrete quantity and volume, and other related parameters.

In addition to providing portability, this system also provides accurate control over the quantity of the various ingredients providing for concrete hardness and the operating times of critical functions. This obviates a lack of precision and different concrete hardnesses with current mixing apparatuses.

FIGS. 17A, 17B, and 17C form a flow chart of the software that configures control element 116D as a mix control device that loads desired weights of ingredients into mixer 106 in the proper order and mixes them to form the desired slurry. One can consider that the instructions comprising each flow chart element for each period of time that these instructions execute within control element 116D, actually configure control element 116D as a physical, electronic element performing the function indicated in the flow chart element.

In general, control element 116D executes the FIGS. 17A-17C instructions at intervals sufficiently short to assure that the correct weights of the ingredients are provided to mixer 106. Often, control elements maintain a list of all routines active at any given time, and each routine is executed in order. The mix control device software of FIGS. 17A-17C comprises activity elements such as element 307 and decision elements such as element 317. Activity elements perform some sort of data manipulation, such as moving data, adding two values, etc. Decision elements select one of two paths for instruction execution based on some type of mathematical test. On occasion, some data manipulation may form a part of a decision element.

Turning first to FIG. 17A, element 303 is the starting point for the mix control software. Activity element 305 then sets the MX signal on path 108D to set the mixer speed to low.

Element 307 symbolizes software that causes control element 106D to clear the mixer weight register (MWR) 116G and sets the desired ingredient weight values W, G, and S for water, cement (gypsum), and sand respectively. Element 307 may include inputs from keyboard 116B provided by an operator that set the desired ingredient weights.

Element 310 symbolizes the instructions that cause control element 116D to issue the AW signal to pump 128B with a high flow level to start pump 128B adding water to mixer 106. Instruction execution then proceeds to activity element 314, which essentially configure control element 116D to function as blender weight monitor 116C. Monitor 116C reads the MW₁ and MW₂ signals, digitizes them, and stores them in the MWR 116G.

Decision element 317 tests the value in MWR 116G against 0.9×W. If the MWR 116G value is less than 0.9×W, then execution of instructions returns to activity element 314. The test of MSR against the 0.9×W value allows the system to slow the flow of water during the final stage of loading the water. Slowing the water flow toward the end of the water delivery interval allows for more accurate measurement of the final delivered water weight. The 0.9 factor is nominal and somewhat arbitrary. FIG. 15 shows this value to vary between (approximately) 0.8 and 0.95.

Eventually, as water continues to flow into mixer 106, the MWR 116G value exceeds 0.9×W, and instruction execution continues to activity element 320 which slows the flow of water to mixer 106. The instructions of decision element 323 then test whether the MWR value is ≧W. If so, then the desired weight of water has been loaded into mixer 106 and execution proceeds to activity element 326, which sends the AW signal with the level that stops water flow to mixer 106. If the MWR value is <W, instruction execution returns to activity element 314.

After the activity element 326 instructions have executed, control element 116D starts the actions to load cement into mixer 106. The instructions of activity element 330 execute to issue the MX signal on path 108E, to run the mixer 106 at low speed. Then the instructions of activity element 333 cause control element 116D to issue the AG signal on path 108B with the level that runs the cement auger motor 136B at high speed. Cement starts moving to mixer 106 from bin 134, which has been preloaded with cement powder.

Element 336 connects the instructions that FIG. 17A shows to the instructions of FIG. 17B. Execution of instructions on FIG. 17B starts at the connection element A 347 and then proceeds to activity element 350. Element 350 reads the MW₁ and MW₂ signals on paths 107A and 107B and then updates the MWR value in memory element 116G.

Then decision element 353 tests whether W+(0.9×G) is less than the MWR value. If true then execution returns to connector element A 347 and weight is recalculated.

If W+(0.9×G) is not less than the MWR value then instruction execution proceeds to activity element 356, which sets the rate of cement flow to the slow level. Here too, the 0.9 factor is nominal, and simply provides an interval at the end of cement delivery with a slow delivery rate to allow more accurate weighing and final cement weight.

The instructions of activity element 358 slow the mixer 106, which also allows scales 106E to more accurately weigh mixer 106. Next, the instructions of decision element 360 test whether the value in the MWR is greater than W+G. If not true, then execution returns to connector element A 347 and weight is recalculated. If true, then execution proceeds to the instructions of activity element 363, which causes control element 116D to set the AG signal to the value that stops flow of cement to mixer 106.

Next, the activities to load sand into mixer 106 occur. Activity element 366 sets the MX signal to cause elevator 140 to set the speed of mixer 106 to high. The instructions of activity element 365 cause control element 116D to set the sand flow signal AS on path 108C for high flow causing elevator 140 to add sand to mixer 106 at the higher rate. Connector element 368 indicates that instruction execution then moves to connector element B on FIG. 17C.

The instruction elements 373, 375, 376, 377 and 379 in FIG. 17C perform control functions for loading a desired amount of sand into mixer 106 that are very similar to those of FIGS. 17A and 17B that load water and cement. First, the mixer runs at its high speed and the elevator 140 delivers sand at its higher rate to mixer 106.

When control element 106D executes instructions that sense the amount of sand present in mixer 106 is close to its desired weight S, then the instructions of decision element 375 cause control element 106D to execute instructions that slow the mixer 106 and slow the sand delivery. The activity element 391 instructions change the AS signal level to stop the sand conveyor motor 140F after the desired weight of sand has been loaded into mixer 106. Typically, at this point, the mixer 106 stifling rate is increased and the mixer 106 runs until the slurry is completely mixed and is ready for placement.

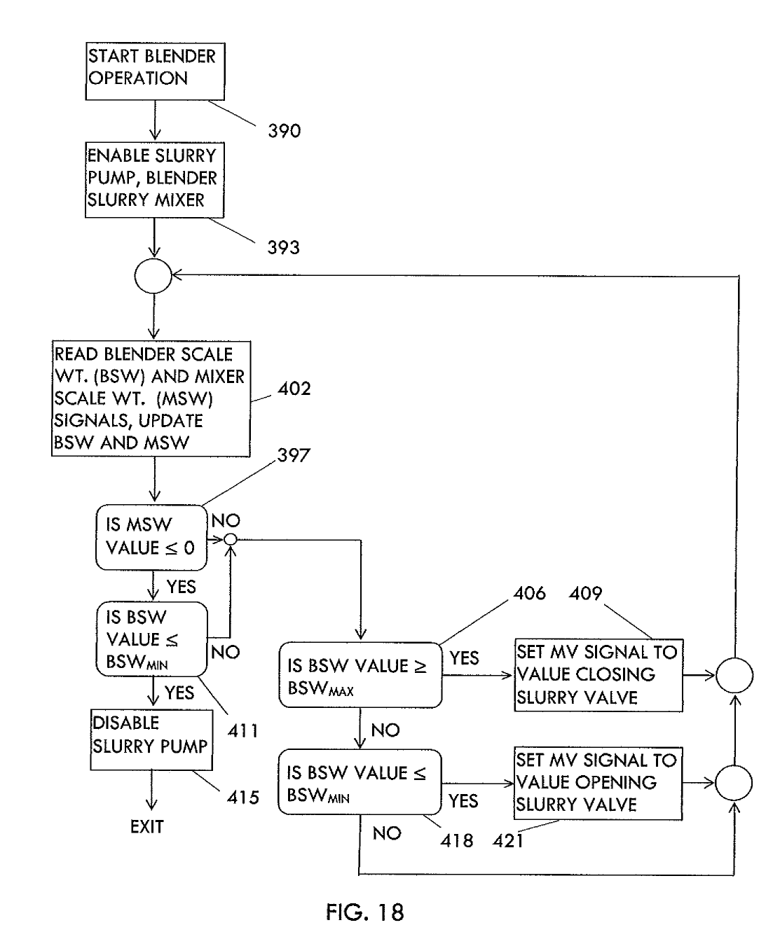

FIG. 18 is a flow chart that explains control of the slurry level in blender 108. As mentioned, it is important that blender 108 not overflow or on the other hand, the level therein fall so low that the blender pump 144G intake is above the slurry level in blender 108. Controller 116 also provides this level control functionality.

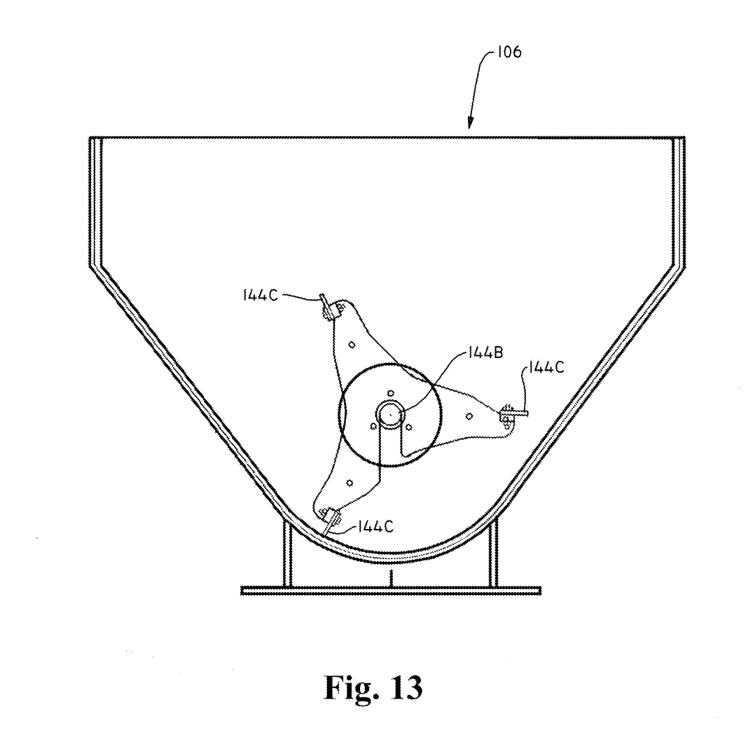

Two levels for the slurry in blender 144 exist, and these are functions of its design. One depends on the maximum allowable level of the slurry in blender 144, specified by a BSW_{MAX} weight value, the other by the minimum allowable level of the slurry in blender 144, specified by a BSW_{MIN} weight value. These values must be prestored in memory 116F prior to operation of slurry pump 144G (FIG. 11).

Blender 144 control starts at connection element 390 and then continues with the instructions of activity element 393. Element 393 places the appropriate value of the BP signal on path 108G to enable operation of the motor 144H that drives slurry pump 144G. This enablement only allows the user on site to start and stop actual motor 144H operation, and does not cause pump 144G to operate.

Execution then proceeds to the instructions of activity element 402. These instructions read the blender weight (BW) from scale 144F, which is carried on path 107C, and the mixer scale weight on paths 107A and 107B. These values are then stored in memory locations 116H and 116G respectively.

Next, control element 116D executes the instructions that decision element 397 symbolizes, to determine if any slurry remains in mixer 106 that can be moved to blender 144. If slurry remains in mixer 106, then instruction execution transfers to decision element 406. If not, then the instructions that decision element 411 symbolize are executed.

Decision element 411 test whether any slurry remains in blender 144 is still available for placement. If so, then execution proceeds to decision element 406. If not then the slurry pump motor 144H is disabled, so that a user cannot activate pump motor 144h through error. These instructions thus make two tests, to determine if controller 116 should allow pump 144G to operate.

The decision element 406 instruction execution begins after decision element 397 has determined that slurry still remains in mixer 106. Decision element 406 tests whether the slurry level in blender 144 is too high. If so, then control element 116D executes the instructions of activity element 409 which sets to close the MV signal that path 108D carries to the mixer valve 142. If untrue, then the instructions of decision element 418 are executed.

If the BSW value is less than BSW_{MAX}, then the instructions of decision element 418 execute, to test whether the blender scale weight BSW is ≦BSW_{MIN}. If so, then more slurry must flow from mixer 106 to blender 144. The instructions of activity element 373 execute, to issue a MV signal with the level that opens the mixer valve 142A. The instruction execution then returns to decision element 357.

Of course, all of these control activities can use proportional regulation, as opposed to merely on and off regulation. These are well known in control theory.

The apparatus described hereinbefore can produce cementitious slurry on site with very accurately measured constituents using a minimum amount of time. It will be understood that some steps and/or equipments could be eliminated in producing cement on site, but with less precision and with more time being required.

Although the invention has been described with regard to certain preferred example embodiments, it is to be understood that the present disclosure has been made by way of example only, and that the above simplifications and all other improvements, changes, modifications, details of construction, combination and arrangement of parts, control means and program steps may be resorted to without departing from the spirit and scope of the invention. Such simplifications, improvements, changes, and modifications within the skill of the art are intended to be covered by the scope of the appended claims.

What is claimed is:

1. A system for delivering preselected weights of a liquid and at least a first particulate mass material to a mixing chamber, comprising:
a) sources for the liquid and the particulate mass;
b) at least one mixing chamber;
c) first and second delivery devices for sequentially and separately transporting the liquid and the at least one particulate mass material to the mixing chamber responsive to first and second delivery control signals, each delivery control signal having second and third values causing the associated delivery device to transport the associated material to the mixing chamber at respectively fast and slow speeds, and a first value stopping the associated delivery device from transporting the associated material to the mixing chamber;
d) a scale supporting at least a portion of the mixing chamber, and providing a mixer weight signal indicating the current weight in the mixing chamber; and
e) a controller receiving a liquid weight signal encoding the preselected liquid weight, a first particulate mass weight signal encoding the preselected particulate mass weight, and the mixer weight signal from the scale, and
i) recording the current weight of the mixing chamber as the first starting mixer weight, and then providing the first delivery signal with one of the second and third values thereof to the first delivery device and periodically recording the current weight of the mixing chamber, and responsive to the current mixer weight less the first starting mixer weight equaling or exceeding one of the preselected liquid and particulate mass weights, providing the first delivery signal with the first value thereof to the first delivery device, and
ii) again recording the current weight of the mixing chamber as the second starting mixer weight, and providing the second delivery signal with one of the second and third values thereof to the second delivery device and periodically recording the current weight of the mixing chamber, and responsive to the current mixer weight less the second starting mixer weight equaling or exceeding the other of the preselected liquid and particulate mass weights, providing the second delivery signal with the first value thereof to the second delivery device.

2. The system of claim 1, wherein the first delivery device comprises at least one of a liquid pump and a liquid valve, and wherein the controller provides the first delivery signal with one of the second and third values to the first delivery device before providing the second delivery signal with one of the second and third values to the second delivery device.

3. The system of claim 2, wherein the controller provides for at least one delivery device, the third value of the associated delivery signal for a period of time, after which the controller provides the second value of the delivery signal.

4. The system of claim 3, wherein the duration of the third level of at least one delivery control signal is substantially longer than the duration of the third level of the delivery control signal.

5. The system of claim 4, wherein the mixing chamber has a mixer valve for discharging material contained within the mixing chamber said mixer valve opening responsive to a first level of a mixer valve signal and closing responsive to a second level of the mixer valve signal, and including a blender having an upper opening, said upper opening mounted below the mixing chamber valve, for receiving through the valve, material held within the mixing chamber, and wherein the controller provides the mixer valve signal to the mixer valve.

6. The system of claim 5, including a scale supporting at least a portion of the blender, and providing to the controller a blender weight signal encoding a value indicative of the blender weight.

7. The system of claim 6, wherein the controller provides the mixer valve signal to the mixer valve with a value dependent on the blender weight signal.

8. The system of claim 4, wherein the controller provides at least one delivery control signal with the second level when the current mixer weight less the starting mixer weight for the associated delivery control signal is within about 85-95% of the associated preselected weight.

9. The system of claim 2, wherein the system further comprises a third delivery device for sequentially and separately transporting a second particulate mass material to the mixing chamber responsive to a third delivery control signal, said third delivery control signal having second and third values causing the third delivery device to transport the associated material to the mixing chamber at respectively slow and fast rates, and a first value stopping the associated delivery device from transporting the associated material to the mixing chamber, wherein the controller again records the current weight of the mixing chamber as the third starting mixer weight and receives a second particulate mass weight signal encoding the preselected particulate mass weight, and provides the third delivery signal with one of the second and third values thereof to the third delivery device and periodically records the current weight of the mixing chamber, and responsive to the current mixer weight less the third starting mixer weight equaling or exceeding the third preselected particulate mass weight, providing the third delivery signal with the first value thereof to the third delivery device.

10. The system of claim 3, wherein the mixing chamber, responsive to first and second levels of a mixer signal runs at lower and higher operating speeds, and wherein the controller provides the mixer signal with the first level substantially concurrent with the second level of a delivery control signal, and the third level substantially concurrent with the third level of a delivery control signal.
